(19) United States
(12) Patent Application Publication
(10) Pub. No.: US 2026/0247134 A1
(43) Pub. Date: Aug. 20, 2026

(54) NON-TERRESTRIAL NETWORK CAPABILITY

(71) Applicant: QUALCOMM Incorporated, San Diego, CA (US)

(72) Inventors: Lianghai JI, San Diego, CA (US); Kangqi LIU, San Diego, CA (US); Weimin DUAN, San Diego, CA (US)

(21) Appl. No.: 19/056,485

(22) Filed: Feb. 18, 2025

(51) Int. Cl. H04W 8/22; H04W 76/20; H04W 84/06

(52) U.S. Cl. CPC H04W 8/22; H04W 76/20; H04W 84/06

(57) ABSTRACT

Various aspects of the present disclosure generally relate to wireless communication. In some aspects, a user equipment (UE) may receive a cell type indication for cell type information associated with a network node that supports communication via one or more of a terrestrial network mode or a non-terrestrial network (NTN) mode. The UE may transmit, to the network node, a communication in accordance with one or more parameters for the NTN mode, wherein the one or more parameters for the NTN mode are associated with the cell type information of the network node that supports communication via the terrestrial network mode. Numerous other aspects are described.

### FIELD OF THE DISCLOSURE

Aspects of the present disclosure generally relate to wireless communication and specifically relate to techniques, apparatuses, and methods associated with non-terrestrial network capabilities.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive a cell type indication for cell type information associated with a network node that supports communication via one or more of a terrestrial network (TN) mode or a non-terrestrial network (NTN) mode. The one or more processors may be configured to transmit, to the network node, a communication in accordance with one or more parameters for the NTN mode, wherein the one or more parameters for the NTN mode are associated with the cell type information of the network node that supports communication via the TN mode.

Some aspects described herein relate to a network node for wireless communication. The network node may include one or more memories and one or more processors coupled to the one or more memories. The one or more processors may be configured to transmit, to a first UE, a cell type indication for cell type information associated with support for communication via one or more of a TN mode or an NTN mode. The one or more processors may be configured to receive, from the first UE, a first communication in accordance with one or more parameters for the NTN mode, wherein the one or more parameters for the NTN mode are associated with the cell type information.

Some aspects described herein relate to a method of wireless communication performed by a UE. The method may include receiving a cell type indication for cell type information associated with a network node that supports communication via one or more of a TN mode or an NTN mode. The method may include transmitting, to the network node, a communication in accordance with one or more parameters for the NTN mode, wherein the one or more parameters for the NTN mode are associated with the cell type information of the network node that supports communication via the TN mode.

Some aspects described herein relate to a method of wireless communication performed by a network node. The method may include transmitting, to a first UE, a cell type indication for cell type information associated with support for communication via one or more of a TN mode or an NTN mode. The method may include receiving, from the first UE, a first communication in accordance with one or more parameters for the NTN mode, wherein the one or more parameters for the NTN mode are associated with the cell type information.

Some aspects described herein relate to a non-transitory computer-readable medium that stores a set of instructions for wireless communication by a UE. The set of instructions, when executed by one or more processors of the UE, may cause the UE to receive a cell type indication for cell type information associated with a network node that supports communication via one or more of a TN mode or an NTN mode. The set of instructions, when executed by one or more processors of the UE, may cause the UE to transmit, to the network node, a communication in accordance with one or more parameters for the NTN mode, wherein the one or more parameters for the NTN mode are associated with the cell type information of the network node that supports communication via the TN mode.

Some aspects described herein relate to a non-transitory computer-readable medium that stores a set of instructions for wireless communication by a network node. The set of instructions, when executed by one or more processors of the network node, may cause the network node to transmit, to a first UE, a cell type indication for cell type information associated with support for communication via one or more of a TN mode or an NTN mode. The set of instructions, when executed by one or more processors of the network node, may cause the network node to receive, from the first UE, a first communication in accordance with one or more parameters for the NTN mode, wherein the one or more parameters for the NTN mode are associated with the cell type information.

Some aspects described herein relate to an apparatus for wireless communication. The apparatus may include means for receiving a cell type indication for cell type information associated with a network node that supports communication via one or more of a TN mode or an NTN mode. The apparatus may include means for transmitting, to the network node, a communication in accordance with one or more parameters for the NTN mode, wherein the one or more parameters for the NTN mode are associated with the cell type information of the network node that supports communication via the TN mode.

Some aspects described herein relate to an apparatus for wireless communication. The apparatus may include means for transmitting, to a first UE, a cell type indication for cell type information associated with support for communication via one or more of a TN mode or an NTN mode. The apparatus may include means for receiving, from the first UE, a first communication in accordance with one or more parameters for the NTN mode, wherein the one or more parameters for the NTN mode are associated with the cell type information.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of a regenerative satellite deployment and an example of a transparent satellite deployment in a non-terrestrial network (NTN), in accordance with the present disclosure.

FIG. 4 is a diagram illustrating an example associated with an NTN network node communicating with a first user equipment (UE) and a second UE, in accordance with the present disclosure.

FIG. 5 is a diagram illustrating an example process performed, for example, at a UE or an apparatus of a UE, in accordance with the present disclosure.

FIG. 6 is a diagram illustrating an example process performed, for example, at a network node or an apparatus of a network node, in accordance with the present disclosure.

FIG. 7 is a diagram of an example apparatus for wireless communication, in accordance with the present disclosure.

FIG. 8 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Terrestrial networks (TNs) may refer to networks in which wireless communication is facilitated between ground-based infrastructure components (e.g., network nodes such as base stations or access points) and a user equipment (UE). The communication within a TN may be implemented using electromagnetic signals transmitted through terrestrial communication links, which may include cellular, Wi-Fi, or other wireless communication protocols. TNs may provide connectivity over defined geographic areas and may be distinguished from non-terrestrial networks (NTNs), which use space-based infrastructure to enable communication. For example, NTNs may facilitate wireless communication via satellite constellations, high-altitude platforms, or other airborne communication nodes that enable communication links to be established with UEs, TN components (e.g., a TN network node), and/or a combination thereof, among other examples. NTNs may provide a broader coverage area for wireless communication than TNs.

Compared to communicating with a TN, a UE may experience a larger time delay and greater Doppler effect when communicating with an NTN. Accordingly, the UE (referred to below as an NTN-capable UE) may be equipped or configured to compensate for the differences in time delay and Doppler effect for TN and NTN communications. Additionally, because not all UEs may be equipped or configured for NTN communication, NTN network nodes may be modified to allow legacy UEs (e.g., UEs that are not otherwise equipped or configured for NTN communication) to communicate with the NTN.

For example, to communicate with NTN-capable UEs and legacy UEs, the NTN network node may establish two cells (e.g., Cell A and Cell B). Cell A may serve legacy UEs and Cell B may serve NTN-capable UEs. Establishing different cells (e.g., Cell A and Cell B) for the legacy UEs and the NTN-equipped UEs can increase signaling overhead and mutual interference.

Various aspects relate generally to NTN communication. Some aspects more specifically relate to NTN-capable UEs. Other aspects more specifically relate to NTN network nodes that can communicate with NTN-capable UEs and legacy UEs. In some aspects, an NTN-capable UE receives a cell type indication. The cell type indication may indicate that a cell serving the NTN-capable UE is served by an NTN network node (e.g., a satellite). If a legacy UE joins the cell, the NTN network node may indicate, to the NTN-capable UE, that the cell is also servicing a legacy UE in a TN mode. The NTN-capable UE may continue to communicate with the NTN network node in the TN mode.

Particular aspects of the subject matter described in this disclosure can be implemented to realize one or more of the following potential advantages. In some examples, the described techniques can be used to allow a single NTN cell to serve legacy UEs and NTN-capable UEs. Additionally, using a single cell to serve both the legacy UEs and the NTN-capable UEs can reduce signaling overhead and interference that would be caused by establishing multiple cells for the NTN network node. Further, using a single NTN network node for both NTN-capable UEs and legacy UEs can be more cost effective, and use less energy, than deploying both NTN network nodes and TN network nodes to serve the NTN-capable UEs and legacy UEs, respectively.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

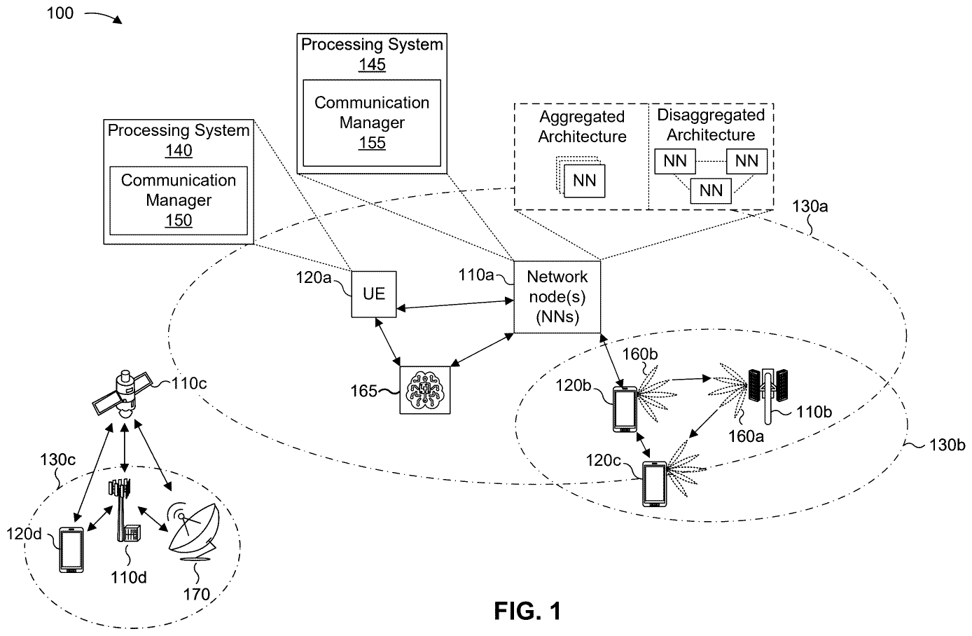

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, a network node 110c, and a network node 110d. The network nodes 110 may support communications with multiple UEs 120. For example, in FIG. 1, the network nodes 110 support communication with a UE 120a, a UE 120b, a UE 120c, and a UE 120d. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

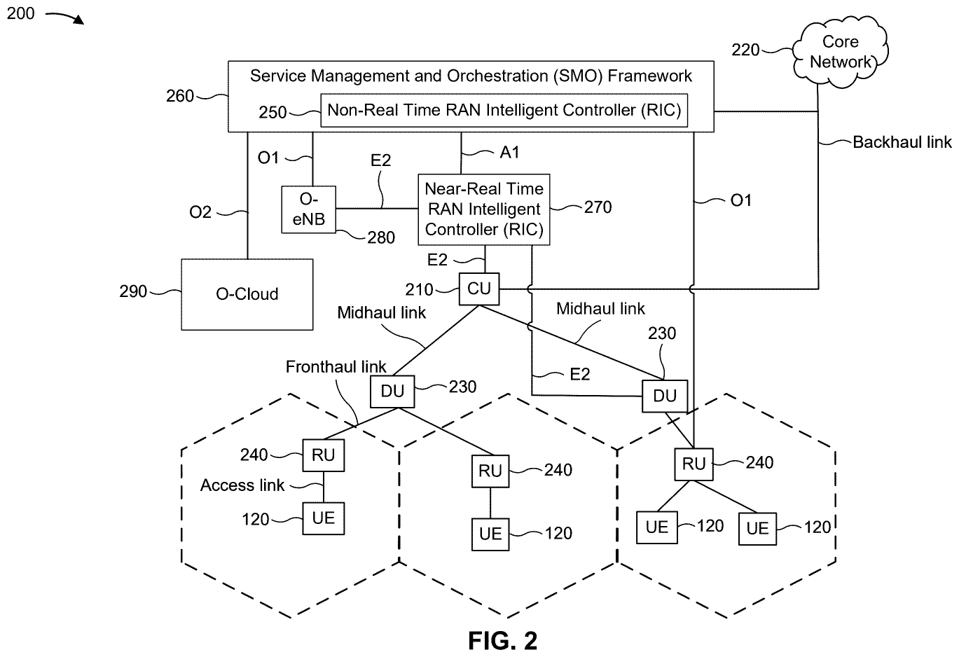

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the

AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

As indicated above, a network node 110 may be a terrestrial network node 110 (for example, a terrestrial base station or entity of a disaggregated base station) or an NTN network node 110. In the example shown in FIG. 1, the network node 110c may be an NTN network node 110 and the cell 130c may be an NTN cell. For example, the wireless communication network 100 may include one or more NTN deployments including an NTN network node 110 and/or a relay station. In some examples, a relay station in an NTN deployment may be referred to as a “non-terrestrial relay station.” An NTN may facilitate access to the wireless communication network 100 for remote areas that may not otherwise be within a coverage area of a terrestrial network node 110, such as over water or remote areas in which a terrestrial network is not deployed. An NTN may provide connectivity for various applications, including satellite communications, IoT, MTC, and/or other applications. An NTN network node 110 may include a satellite, a manned aircraft system, or an unmanned aircraft system (UAS) platform, among other examples. A satellite may include a low-earth orbit (LEO) satellite, a medium-earth orbit (MEO) satellite, a geostationary earth orbit (GEO) satellite, and/or a high elliptical orbit (HEO) satellite, among other examples. A manned aircraft system may include an airplane, a helicopter, and/or a dirigible, among other examples. A UAS platform may include a high-altitude platform station (HAPS), a balloon, a dirigible, and/or an airplane, among other examples.

An NTN network node 110 may communicate directly and/or indirectly with other entities in the wireless communication network 100 using NTN communication. The other entities may include UEs 120 (for example, the UE 120d), other NTN network nodes 110 in the one or more NTN deployments, other types of network nodes 110 (for example, stationary, terrestrial, and/or ground-based network nodes, such as the network node 110d), relay stations, and/or one or more components and/or devices included in or coupled with a core network of the wireless communication network 100. For example, an NTN network node 110 may communicate with a UE 120 via a service link (for example, where the service link includes an access link). Additionally or alternatively, an NTN network node 110 may communicate with a gateway 170 (for example, a terrestrial node providing connectivity for the NTN network node 110 to a data network or a core network) via a feeder link (for example, where the feeder link is associated with an N2 or an N3 interface). Additionally or alternatively, NTN network nodes 110 may communicate directly with one another via an inter-satellite link (ISL). In some examples, an NTN deployment may be transparent (for example, where the NTN network node 110 operates in a similar manner as a repeater or relay and/or where an access link does not terminate at the NTN network node 110). In some other examples, an NTN deployment may be regenerative. For example, an access link may terminate at the NTN network node 110, and the NTN network node 110 may regenerate a signal (such as by performing signal processing or enhancement, which may include error correction, modulation or demodulation, or amplification).

In some aspects, the UE 120 may include a communication manager 150. As described in more detail elsewhere herein, the communication manager 150 may receive a cell type indication for cell type information associated with a network node (e.g., network node 110c) that supports communication via one or more of a TN mode or an NTN mode; and transmit, to the network node, a communication in accordance with one or more parameters for the NTN mode. The one or more parameters for the NTN mode may be associated with the cell type information of the network node that supports communication via the TN mode. Additionally, or alternatively, the communication manager 150 may perform one or more other operations described herein.

In some aspects, the network node 110 may include a communication manager 155. As described in more detail elsewhere herein, the communication manager 155 may transmit, to a first UE (e.g., UE 120d), a cell type indication for cell type information associated with support for communication via one or more of a TN mode or an NTN mode; and receive, from the first UE, a first communication in accordance with one or more parameters for the NTN mode. The one or more parameters for the NTN mode may be associated with the cell type information. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

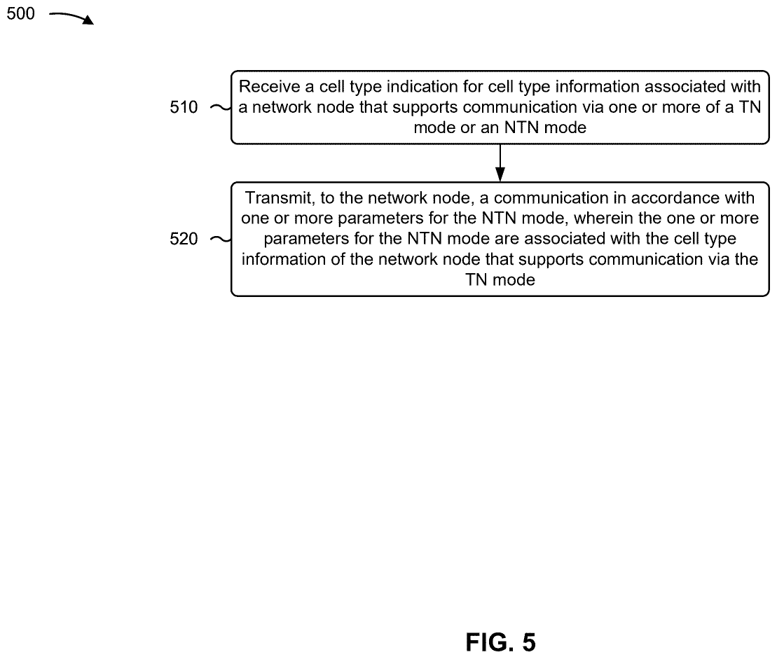

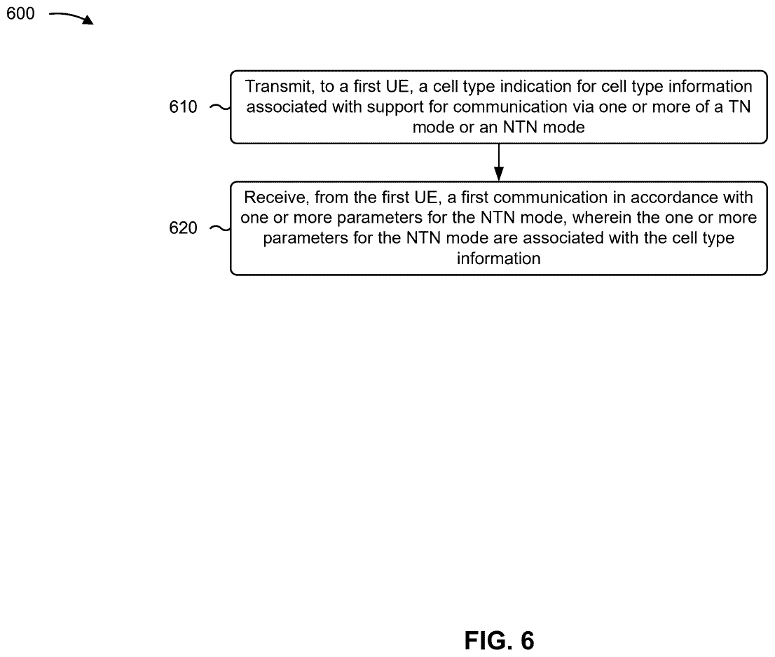

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with an NTN mode capability, as described in more detail elsewhere herein. For example, the processing system 145 of the network node 110, the processing system 140 of the UE 120, the CU 210, the DU 230, or the RU 240 may perform or direct operations of, for example, process 500 of FIG. 5, process 600 of FIG. 6, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 500 of FIG. 5, process 600 of FIG. 6, or other processes as described herein. In some examples, executing instructions may include running the instructions, converting the instructions, compiling the instructions, and/or interpreting the instructions, among other examples.

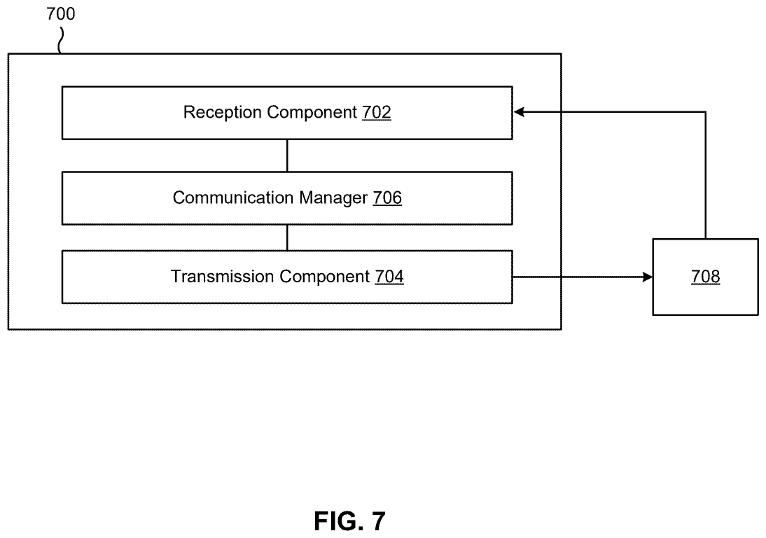

In some aspects, the UE 120 includes means for receiving a cell type indication for cell type information associated with a network node 110 that supports communication via one or more of a TN mode or an NTN mode; and/or means for transmitting, to the network node 110, a communication in accordance with one or more parameters for the NTN mode. The one or more parameters for the NTN mode may be associated with the cell type information of the network node 110 that supports communication via the TN mode. The means for the UE 120 to perform operations described herein may include, for example, one or more of communication manager 150, processing system 140, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

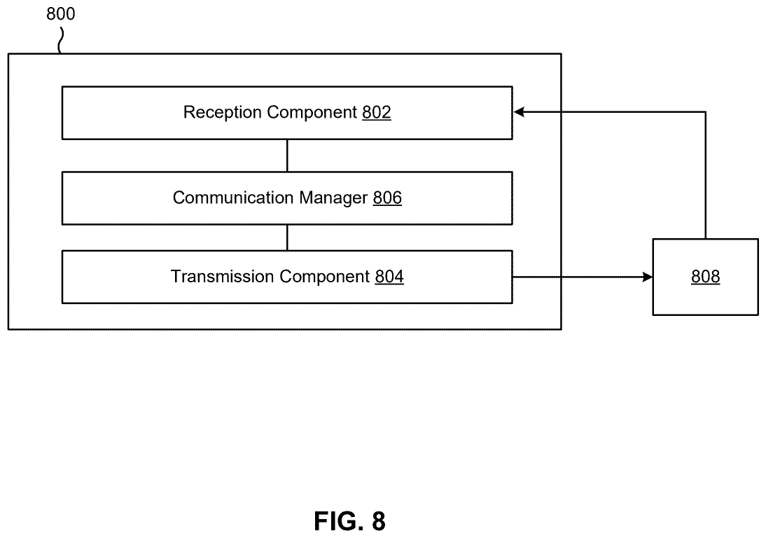

In some aspects, the network node 110 includes means for transmitting, to a UE 120, a cell type indication for cell type information associated with support for communication via one or more of a TN mode or an NTN mode; and/or means for receiving, from the UE, a first communication in accordance with one or more parameters for the NTN mode. The one or more parameters for the NTN mode are associated with the cell type information. The means for the network node 110 to perform operations described herein may include, for example, one or more of communication manager 155, processing system 145, a radio, one or more RF chains, one or more transceivers, one or more antennas, one or more modems, a reception component (for example, reception component 802 depicted and described in connection with FIG. 8), and/or a transmission component (for example, transmission component 804 depicted and described in connection with FIG. 8), among other examples.

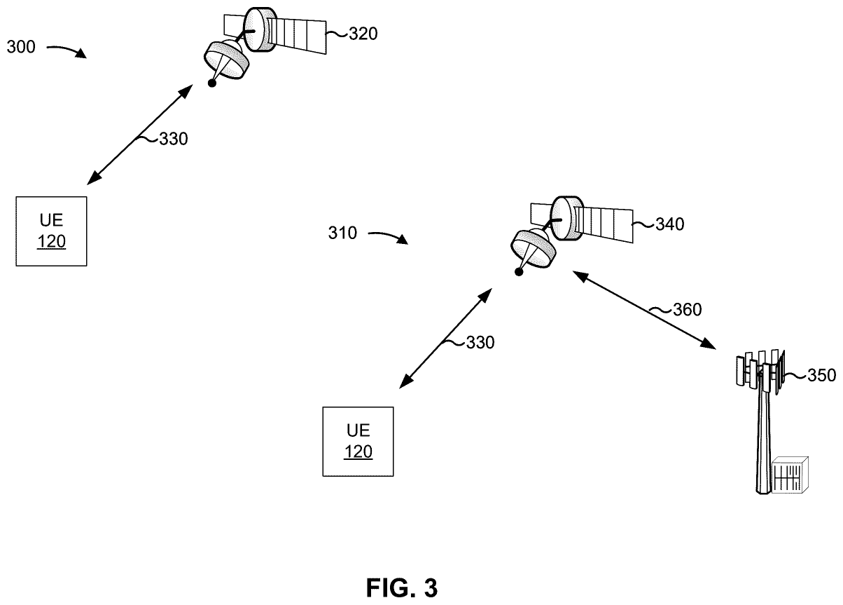

FIG. 3 is a diagram illustrating an example 300 of a regenerative satellite deployment and an example 310 of a transparent satellite deployment in an NTN, in accordance with the present disclosure.

Example 300 shows a regenerative satellite deployment. In example 300, a UE 120 is served by a satellite 320 via a service link 330. For example, the satellite 320 may include a network node 110 (e.g., network node 110a) or a gNB. In some aspects, the satellite 320 may be referred to as a non-terrestrial base station, a regenerative repeater, or an on-board processing repeater. In some aspects, the satellite 320 may demodulate an uplink radio frequency signal, and may modulate a baseband signal derived from the uplink radio signal to produce a downlink radio frequency transmission. The satellite 320 may transmit the downlink radio frequency signal on the service link 330. The satellite 320 may provide a cell that covers the UE 120.

Example 310 shows a transparent satellite deployment, which may also be referred to as a bent-pipe satellite deployment. In example 310, a UE 120 is served by a satellite 340 via the service link 330. The satellite 340 may be a transparent satellite.

The satellite 340 may relay a signal received from gateway 350 via a feeder link 360. For example, the satellite may receive an uplink radio frequency transmission, and may transmit a downlink radio frequency transmission without demodulating the uplink radio frequency transmission. In some aspects, the satellite may frequency convert the uplink radio frequency transmission received on the service link 330 to a frequency of the uplink radio frequency transmission on the feeder link 360, and may amplify and/or filter the uplink radio frequency transmission. In some aspects, the UEs 120 shown in example 300 and example 310 may be associated with a GNSS capability or a Global Positioning System (GPS) capability, though not all UEs have such capabilities. The satellite 340 may provide a cell that covers the UE 120.

The service link 330 may include a link between the satellite 340 and the UE 120, and may include one or more of an uplink or a downlink. The feeder link 360 may include a link between the satellite 340 and the gateway 350, and may include one or more of an uplink (e.g., from the UE 120 to the gateway 350) or a downlink (e.g., from the gateway 350 to the UE 120).

The feeder link 360 and the service link 330 may each experience Doppler effects due to the movement of the satellites 320 and 340, and potentially movement of a UE 120. These Doppler effects may be significantly larger than in a TN. The Doppler effect on the feeder link 360 may be compensated for to some degree, but may still be associated with some amount of uncompensated frequency error. Furthermore, the gateway 350 may be associated with a residual frequency error, and/or the satellite 320/340 may be associated with an on-board frequency error. These sources of frequency error may cause a received downlink frequency at the UE 120 to drift from a target downlink frequency.

As discussed above, not all UEs 120 may be capable of NTN communication (e.g., communication with NTN network nodes such as network node) . Accordingly, if a legacy UE (e.g., a UE that is not equipped for NTN communication) joins a cell served by an NTN network node (e.g., satellite 320 and/or satellite 340), the NTN network node may be configured to switch from an NTN mode to a TN mode for communication with one or more legacy UEs and with one or more NTN-capable UEs, as discussed in greater detail below.

As indicated above, FIG. 3 is provided as an example. Other examples may differ from what is described with regard to FIG. 3.

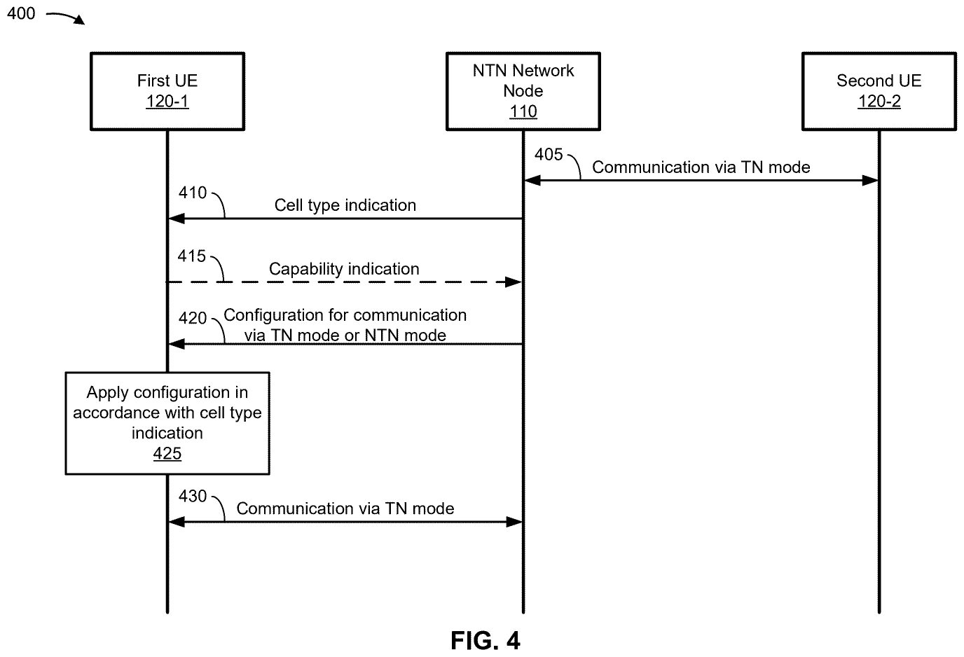

FIG. 4 is a diagram illustrating an example 400 associated with an NTN network node communicating with a first UE and a second UE, in accordance with the present disclosure. As shown in FIG. 4, a network node 110 (e.g., an NTN network node) may communicate with a first UE 120-1 and a second UE 120-2. In some aspects, the first UE 120-1 may be an NTN-capable UE (e.g., a UE configured and/or equipped to communicate with an NTN network node operating in an NTN mode). In some aspects, the second UE 120-2 may be a non NTN-capable UE (e.g., a UE that is not capable of communicating with the network node 110 in an NTN mode but is capable of communicating with the network node 110 in a TN mode).

In some aspects, the TN mode may refer to an operation of a UE where the UE does not compensate a delay and/or a Doppler shift associated with the NTN communication (e.g., to compensate for the delay and/or the Doppler shift associated with a service link of the UE based on the UE's position information (e.g., the GNSS location of the UE)). Alternatively or additionally, the TN mode may refer to an operation of a UE where the UE does not use its location information (e.g., the GNSS position) to compensate for a delay difference and/or a Doppler shift difference associated with the NTN communication. In one example, the delay difference and/or the Doppler shift difference may be a difference between the delay and/or Doppler shift of the UE's service link and a delay and/or a Doppler shift indicated by the network node to the UE. Accordingly, the UE, when operating in the TN mode, may perform the compensation based on the delay value and/or the Doppler shift indicated by the network node. In another example, the delay difference and/or the Doppler shift difference may be a difference between the delay and/or Doppler shift of the UE's service link and a delay and/or a Doppler shift of a service link between the satellite and a reference location, which may be provided by the network node to the UE. Accordingly, the UE, when operating in the TN mode, may calculate and perform the compensation based on the delay and/or the Doppler shift to be experienced at the indicated reference location.

In some aspects, the NTN mode may refer to an operation of a UE where the UE uses position information (e.g. the GNSS location of the UE) to compensate for a delay and/or a Doppler shift associated to the NTN communication (e.g., to compensate for the delay and/or the Doppler shift associated with a service link of the UE). Alternatively or additionally, the NTN mode may refer to an operation of a UE where the UE uses its location information (e.g., the GNSS position of the UE) to compensate for a delay difference and/or a Doppler shift difference associated with the NTN communication. In one example, the delay difference and/or the Doppler shift difference may be a difference between the delay and/or the Doppler shift of the UE's service link and a delay and/or a Doppler shift indicated by the network node to the UE. In this example, the indicated delay and/or Doppler shift may be compensated by the network node. In another example, the delay difference and/or the Doppler shift difference may be a difference between the delay and/or Doppler shift of the UE's service link and a delay and/or a Doppler shift of the service link between the satellite and a reference location, which may be provided by the network node to the UE. In this example, the delay and/or the Doppler shift of the service link between the satellite and the indicated reference location may be compensated for by the network node. Accordingly, the TN mode may differ from the NTN mode in a way that a first UE operating in the NTN mode and a second UE operating in the TN mode may access the same cell using different information and/or procedures to compensate for the delay and/or the Doppler shift associated with the same cell.

As shown by reference number 405, the network node 110 and the second UE 120-2 may communicate via a TN mode. For example, even though the network node 110 is an NTN network node, the second UE 120-2 may operate as though the network node 110 were a TN network node with a TN serving cell. Accordingly, the second UE 120-2 may not compensate for delays and/or Doppler shift associated with NTN communications. Rather, the network node 110 may adjust one or more transmission or reception parameters to compensate for delays and/or Doppler shift. For example, the network node 110 may be configured to pre-compensate for a downlink Doppler frequency and/or uplink Doppler frequency corresponding to a center of a beam or cell.

Alternatively, in some aspects, the second UE 120-2 may compensate for delays and/or Doppler shift associated with NTN communications, in accordance with information other than location information of the second UE 120-2, which may cause a large residual error for the delay and Doppler shift compensation. For example, the network node 110 may indicate, to the second UE 120-2, a value to be applied for the delay and Doppler shift compensation. In another example, the network node 110 may indicate, to the second UE 120-2, a reference location to be used for the delay and Doppler shift calculation and compensation. The network node 110 may address the large residual error by, for example, applying a larger reception window in the time-domain and/or-frequency domain.

As shown by reference number 410, the network node 110 may transmit, and the first UE 120-1 may receive, a cell type indication. In some aspects, the cell type indication may be associated with the network node 110. In some aspects, the cell type indication may indication that the network node 110 supports communication via the TN mode and/or the NTN mode. In some aspects, the cell type indication may indicate that a cell served by the network node 110, which is an NTN node, but communicating with the second UE 120-2 in a TN mode. In some aspects, the cell type indication may indicate that a cell served by the network node 110 is operating in an NTN node but capable of communicating with both the first UE 120-1 in the NTN mode and the second UE 120-2 in the TN mode. In some aspects, the first UE 120-1 may be configured to communicate with the network node 110 via the TN mode until the first UE 120-1 receives the cell type indication.

In some aspects, the first UE 120-1 may receive, from the network node 110, a reference location indication associated with a reference location. As discussed in greater detail below, the reference location may correspond to a center of a beam or cell. In some aspects, receiving the cell type indication may include receiving the cell type indication via one or more of a master information block (MIB) (e.g., a reserved bit in the MIB), a system information block (SIB), or an RRC communication. For example, in some aspects, a dedicated RRC message may include the cell type indication in a handover command or a conditional handover command. In some aspects, the first UE 120-1 may be configured to communicate with the network node 110 in accordance with cell type information included in the handover command and/or the conditional handover command.

In some aspects, receiving the cell type indication many include receiving the cell type indication while the first UE 120-1 is operating in the TN mode. In some aspects, the cell type information may be associated with one or more information fields or one or more communication parameters, as discussed in greater detail below. In some aspects, the cell type indication may be implicitly indicated to the first UE 120-1 without, for example, adding a new information element in one or more existing messages. For example, in some aspects, the first UE 120-1 may be configured to detect that the cell is not barred for non-NTN-capable UEs in accordance with a cellBarred bit of the MIB. Additionally or alternatively, in some aspects, the cell type indication may be associated with a SIB19 communication. The first UE 120-1 may detect that the cell transmits a SIB19 (e.g., an NTN SIB) that carries satellite ephemeris information of the cell served by the network node 110. The first UE 120-1 may be configured to determine the cell type in accordance with the SIB19, the MIB, cell barring information, and/or a combination thereof, among other examples. Alternatively or additionally, in some aspects, the first UE 120-1 may be configured to determine that the cell is capable of serving NTN-capable UEs and non-NTN-capable UEs if the cell operates in a TN band when the network node 110 transmits the SIB19 carrying the satellite ephemeris information as the serving cell information.

As shown by reference number 415, the first UE 120-1 may transmit, and the network node 110 may receive, an NTN indication. In some aspects, the NTN indication may indicate a capability associated with the first UE 120-1 operating in the NTN mode while the network node 110 communicates with the second UE 120-2 in the TN mode. In some aspects, the NTN indication may indicate, to the network node 110, that the first UE 120-1 is capable of communicating with the network node 110 even though the network node 110 is serving a cell in the TN mode for communication with the second UE 120-2. In some aspects, the first UE 120-1 may transmit the NTN indication via a PRACH preamble. In some aspects, the first UE 120-1 may transmit the NTN indication via a MAC-CE. In some aspects, the first UE 120-1 may transmit the NTN indication via an RRC message.

As shown by reference number 420, the network node 110 may transmit, and the first UE 120-1 may receive, an NTN configuration or a TN configuration. The NTN configuration may configure the first UE 120-1 to communicate with the network node 110 via the NTN mode. The TN configuration may configure the first UE 120-1 to communicate with the network node 110 via the TN mode. In some aspects, the configuration transmitted by the network node 110 may be based, at least in part, on the cell type indication transmitted to the first UE 120-1. For example, if the cell type indication indicates that the network node 110 is operating in the NTN mode, the configuration transmitted to the first UE 120-1 may include the NTN configuration. Alternatively, if the cell type indication indicates that the network node 110 is operating in the TN mode, the configuration transmitted to the first UE 120-1 may include the TN configuration. In another example, if the cell type indication indicates that the network node 110 can support one or more UEs operating in the TN mode and one or more UEs operating in NTN mode, the configuration transmitted to the first UE 120-1 may include both the TN configuration and the NTN configuration.

As shown by reference number 425, the first UE 120-1 may configure itself in accordance with the TN configuration or the NTN configuration. In some aspects, to configure itself in accordance with the NTN configuration, the first UE 120-1 may apply one or more parameters for the NTN mode. The one or more parameters for the NTN mode may be associated with the cell type information, which as discussed above, may indicate that the network node 110 supports communication via the TN mode. In some aspects, the first UE 120-1 may apply the one or more parameters to communicate with the network node 110 in accordance with one or more of satellite ephemeris information, a location of the first UE 120-1, or the reference location, discussed above. In some aspects, the one or more parameters may include one or more of an uplink Doppler frequency and/or a downlink Doppler frequency. In some aspects, to apply the NTN configuration, the first UE 120-1 may be configured to determine a residual downlink Doppler frequency and compensate for the residual downlink Doppler frequency to, for example, reduce a downlink Doppler frequency error. In some aspects, to apply the NTN configuration, the first UE 120-1 may be configured to determine a residual uplink Doppler frequency and compensate for the residual uplink Doppler frequency to reduce an uplink Doppler frequency error. In some aspects, the first UE 120-1 may be configured to determine an uplink timing shift and apply the uplink timing shift to communications with the network node 110 in the NTN mode. In some aspects, the uplink timing shift may be associated with an offset value in accordance with at least one of the reference location, the location of the first UE 120-1, or satellite ephemeris information.

As shown by reference number 430, the first UE 120-1 and the network node 110 may communicate with one another in accordance with the one or more parameters for the NTN mode. As discussed above, the one or more parameters for the NTN mode may be associated with the cell type information of the network node 110, which supports communication via the TN mode. In some aspects, the first UE 120-1 and network node 110 may communicate in accordance with the uplink timing shift discussed above.

Accordingly, the first UE 120-1 may adjust one or more communication parameters so the network node 110 can support communication with non-NTN-capable UEs such as the second UE 120-2 while also providing improved system performance relative to the first UE 120-1 and the network node 110 communicating via a TN mode. For example, as discussed above, the first UE 120-1 may compensate for the Doppler frequency in an uplink communication and/or in a downlink communication with respect to a center of the beam and/or cell or a reference location on the ground designated by network node 110. The first UE 120-1 may determine a magnitude of a compensation (or pre-compensation) performed by the network node 110 for downlink communications and/or for uplink communications. The first UE 120-1 may determine the magnitude of the compensation (or pre-compensation) in accordance with a center location of the beam and/or cell and the satellite ephemeris information. The first UE 120-1 may also determine an amount of Doppler shift for uplink and/or downlink communications in accordance with a location of the first UE 120-1 and the satellite ephemeris information. In some aspects, the first UE 120-1 may calculate a residual downlink Doppler frequency in accordance with the pre-compensation of downlink communications by the network node 110 and the determined amount of Doppler shift detected by the first UE 120-1 for downlink communications. By calculating the residual downlink Doppler frequency, the first UE 120-1 may acquire and/or track the downlink signals of the cell. In some aspects, while the second UE 120-2 may determine an amount of Doppler shift and/or timing shift for uplink and/or downlink communications in accordance with a value and/or a reference location indicated by NW, the first UE 120-1 may determine an amount of Doppler shift and/or timing shift for uplink and/or downlink communications based, at least in part, on the location information of the first UE 120-1.

In some aspects, the first UE 120-1 may determine and compensate for a residual uplink Doppler frequency in accordance with an amount of compensation and/or pre-compensation in downlink communications and/or uplink communications by the network node 110 and a detected magnitude of Doppler shift calculated or measured by the first UE 120-1. Compensating for the residual uplink Doppler frequency may allow the first UE 120-1 to reduce a residual uplink Doppler frequency error for the network node 110 to receive uplink transmissions from the first UE 120-1 as compared to the error associated with uplink transmissions by the second UE 120-2 received by the network node 110 via the TN mode.

In some aspects, as discussed above, the center location of the beam and/or cell can be transmitted from the network node 110 to the first UE 120-1 as a reference location. In some aspects, the reference location may not be the center of the beam and/or cell. For example, the reference location may be any location, determined by network node 110, and used to perform a downlink Doppler frequency pre-compensation and uplink Doppler frequency compensation for non-NTN-capable UEs (such as the second UE 120-2).

In some aspects, the first UE 120-1 may be configured to calculate and apply an uplink timing shift in accordance with a reference location designated by network node 110. For example, communications between the network node 110 and the second UE 120-2 in the TN mode may be subject to a downlink-uplink offset. An offset value for the downlink-uplink offset may be determined by a round trip time (RTT) of the corresponding beam and/or cell. The network node 110 may implement (e.g., configure and/or schedule) a larger receiving window to accommodate different RTTs for different UEs in the beam and/or cell. In some aspects, the first UE 120-1 may determine a first downlink-uplink offset value in accordance with the reference location and the satellite ephemeris information. In some aspects, the first UE 120-1 may determine a second downlink-uplink offset value for the RTT in accordance with a location of the first UE 120-1 and the satellite ephemeris information. In some aspects, the first UE 120-1 may calculate an RTT difference in accordance with a difference between the first downlink-uplink offset value and the second downlink-uplink offset value. The first UE 120-1 may be configured to apply the RTT difference value as an uplink timing shift for uplink communications with the network node 110. By applying the uplink timing shift, uplink communications from the first UE 120-1 may arrive at the network node 110 be synchronized to the downlink-uplink offset experienced by the network node 110. Accordingly, the RTT difference value may reduce a duration of a receiving window for the network node 110 to receive uplink communications from the first UE 120-1. In some aspects, as discussed above, the reference location may be communicated to the first UE 120-1 via the network node 110, and the network node 110 may use a center of a beam and/or cell as the reference location.

In some aspects, the first UE 120 may transmit one or more uplink communications in accordance with the calculated uplink timing shift. For example, the first UE 120-1 may apply the uplink timing shift to a random access procedure (e.g., a Msg1 RACH preamble, a Msg3 communication, and/or MsgA communication) and/or an uplink message after the random access procedure. By applying the timing shift, the first UE 120-1 and the network node 110 may communicate in accordance with a small receiving window, while the network node 110 communicate with the second UE 120-2 via a larger receiving window to, for example, accommodate a larger timing shift for the network node 110 and second UE 120-2 communicating via the TN mode. In some aspects, for uplink communications after the random access procedure, the network node 110 may avoid and/or reduce the sending of a timing advance command to the first UE 120-1 because the first UE 120-1 may be configured to adjust the uplink timing advance without the timing advance command from the network node 110. Accordingly, signaling overhead may be reduced in the network.

In some aspects, as discussed above, the first UE 120-1 may transmit the NTN indication to the network node 110 in accordance with the cell type information that indicates support, by the network node 110, for the NTN mode for the cell. In some aspects, the NTN indication may indicate, to the network node 110, that the first UE 120-1 is capable of applying (or has already applied) one or more parameters for communicating with the network node 110 via the NTN mode. In some aspects, the network node 110 may configure the first UE 120-1 to communicate with the network node 110 in accordance with the NTN mode as a result of the network node 110 receiving the NTN indication. In some aspects, the NTN indication may be transmitted by the first UE 120-1 to the network node 110 in accordance with a network configuration and/or a pre-configuration at the first UE 120-1. For example, the first UE 120-1 may be configured or pre-configured to use a PRACH preamble configured by the network node 110 to send the NTN indication. Alternatively, the first UE 120-1 may be configured to transmit the NTN indication via a MAC-CE in Msg3, a later PRACH communication, and/or an RRC message containing the UE capability indication. In some aspects, the NTN indication may be transmitted from the first UE 120-1 to the network node 110 via the NTN mode, which may improve network performance.

In some aspects, the network node 110 may transmit the cell type indication to the first UE 120-1 in accordance with one or more criteria. For example, the network node 110 may transmit the cell type indication to the first UE 120-1 as a result of the second UE 120-2 communicating in the cell in accordance with the TN mode.

In some aspects, the network node 110 may reserve and/or configure a set of RACH preambles and/or RACH occasions for the first UE 120-1 to transmit the NTN indication. In some aspects, the network node 110 may transmit the configuration for the first UE 120-1 to transmit the NTN indication via a SIB. The set of RACH preambles and/or RACH occasions may allow the first UE 120-1 to access the cell with improved time and/or frequency compensations during a random access procedure. Additionally, network performance may be improved because the compensations by the first UE 120-1 during the random access procedure for the NTN indication may facilitate a reduced receiving window in the time domain and/or the frequency domain, which may reduce the amount of resources reserved for the random access procedure and, thus, leave more resource available for data communications.

In some aspects, upon receiving the NTN indication, the network node 110 may adjust one or more communication behaviors. For example, the network node 110 may adjust a scheduling behavior, a reception process, and/or a combination thereof, among other examples. In some aspects, the network node 110 may be configured to reserve a cluster, batch, and/or block of time and/or frequency resources for scheduling the uplink communications from the first UE 120-1. The reserved cluster, batch, and/or block of time and/or frequency resources may be allocated only for NTN-capable UEs (e.g., the first UE 120-1) and not for non-NTN-capable UEs (e.g., the second UE 120-2). Accordingly, the network node 110 may use a single reduced receiving window to receive uplink communications multiplexed from one or more NTN-capable UEs. Further, network performance (e.g., a signal-to-noise ratio and/or bit error rate) for receiving the uplink communications from the one or more NTN-capable UEs may be improved because the uplink communications from the NTN-capable UEs may have improved orthogonality as a result of the uplink timing and/or Doppler frequency compensations.

As indicated above, FIG. 4 is provided as an example. Other examples may differ from what is described with respect to FIG. 4.

FIG. 5 is a diagram illustrating an example process 500 performed, for example, at a UE or an apparatus of a UE, in accordance with the present disclosure. Example process 500 is an example where the apparatus or the UE (e.g., UE 120) performs operations associated with an NTN mode capability.

As shown in FIG. 5, in some aspects, process 500 may include receiving a cell type indication for cell type information associated with a network node that supports communication via one or more of a TN mode or an NTN mode (block 510). For example, the UE (e.g., using reception component 702 and/or communication manager 706, depicted in FIG. 7) may receive a cell type indication for cell type information associated with a network node that supports communication via one or more of a TN mode or an NTN mode, as described above.

As further shown in FIG. 5, in some aspects, process 500 may include transmitting, to the network node, a communication in accordance with one or more parameters for the NTN mode, wherein the one or more parameters for the NTN mode are associated with the cell type information of the network node that supports communication via the TN mode (block 520). For example, the UE (e.g., using transmission component 704 and/or communication manager 706, depicted in FIG. 7) may transmit, to the network node, a communication in accordance with one or more parameters for the NTN mode, wherein the one or more parameters for the NTN mode are associated with the cell type information of the network node that supports communication via the TN mode, as described above.

Process 500 may include additional aspects, such as any single aspect or any combination of aspects described below and/or in connection with one or more other processes described elsewhere herein.

In a first aspect, process 500 includes transmitting, to the network node, an NTN indication that indicates a capability associated with operating in the NTN mode.

In a second aspect, alone or in combination with the first aspect, transmitting the NTN indication includes transmitting the NTN indication via a PRACH preamble.

In a third aspect, alone or in combination with one or more of the first and second aspects, transmitting the NTN indication includes transmitting the NTN indication via a MAC-CE.

In a fourth aspect, alone or in combination with one or more of the first through third aspects, process 500 includes receiving one or more of an NTN mode configuration or a TN mode configuration.

In a fifth aspect, alone or in combination with one or more of the first through fourth aspects, transmitting the communication includes applying the one or more parameters to the communication in accordance with at least one of satellite ephemeris information, a UE location, or a reference location.

In a sixth aspect, alone or in combination with one or more of the first through fifth aspects, process 500 includes receiving, from the network node, a reference location indication associated with a reference location.

In a seventh aspect, alone or in combination with one or more of the first through sixth aspects, at least one of the one or more parameters is associated with a reference location.

In an eighth aspect, alone or in combination with one or more of the first through seventh aspects, the one or more parameters include one or more of an uplink Doppler frequency or a downlink Doppler frequency.

In a ninth aspect, alone or in combination with one or more of the first through eighth aspects, process 500 includes determining a residual downlink Doppler frequency, and compensating for the residual downlink Doppler frequency to reduce a downlink Doppler frequency error.

In a tenth aspect, alone or in combination with one or more of the first through ninth aspects, process 500 includes determining a residual uplink Doppler frequency, and compensating for the residual uplink Doppler frequency to reduce an uplink Doppler frequency error.

In an eleventh aspect, alone or in combination with one or more of the first through tenth aspects, process 500 includes determining an uplink timing shift, and wherein transmitting the communication in accordance with the one or more parameters associated with the NTN mode includes transmitting the communication in accordance with the uplink timing shift.

In a twelfth aspect, alone or in combination with one or more of the first through eleventh aspects, the uplink timing shift is associated with an offset value in accordance with at least one of a reference location, a UE location, or satellite ephemeris information.

In a thirteenth aspect, alone or in combination with one or more of the first through twelfth aspects, receiving the cell type indication includes receiving the cell type indication via one or more of a MIB, a SIB, or an RRC communication.

In a fourteenth aspect, alone or in combination with one or more of the first through thirteenth aspects, receiving the cell type indication includes receiving the cell type indication while operating in the TN mode.

In a fifteenth aspect, alone or in combination with one or more of the first through fourteenth aspects, the cell type indication is associated with one or more information fields or one or more communication parameters.

In a sixteenth aspect, alone or in combination with one or more of the first through fifteenth aspects, the cell type indication is associated with a SIB19 communication.

Although FIG. 5 shows example blocks of process 500, in some aspects, process 500 may include additional blocks, fewer blocks, different blocks, or differently arranged blocks than those depicted in FIG. 5. Additionally, or alternatively, two or more of the blocks of process 500 may be performed in parallel.

FIG. 6 is a diagram illustrating an example process 600 performed, for example, at a network node or an apparatus of a network node, in accordance with the present disclosure. Example process 600 is an example where the apparatus or the network node (e.g., network node 110) performs operations associated with an NTN mode capability.

As shown in FIG. 6, in some aspects, process 600 may include transmitting, to a first UE, a cell type indication for cell type information associated with support for communication via one or more of a TN mode or an NTN mode (block 610). For example, the network node (e.g., using transmission component 804 and/or communication manager 806, depicted in FIG. 8) may transmit, to a first UE, a cell type indication for cell type information associated with support for communication via one or more of a TN mode or an NTN mode, as described above.

As further shown in FIG. 6, in some aspects, process 600 may include receiving, from the first UE, a first communication in accordance with one or more parameters for the NTN mode, wherein the one or more parameters for the NTN mode are associated with the cell type information (block 620). For example, the network node (e.g., using reception component 802 and/or communication manager 806, depicted in FIG. 8) may receive, from the first UE, a first communication in accordance with one or more parameters for the NTN mode, wherein the one or more parameters for the NTN mode are associated with the cell type information, as described above.

Process 600 may include additional aspects, such as any single aspect or any combination of aspects described below and/or in connection with one or more other processes described elsewhere herein.

In a first aspect, process 600 includes receiving, from the first UE, an NTN indication that indicates a capability for the first UE to operate in the NTN mode.

In a second aspect, alone or in combination with the first aspect, receiving the NTN indication includes receiving the NTN indication via a PRACH preamble.

In a third aspect, alone or in combination with one or more of the first and second aspects, receiving the NTN indication includes receiving the NTN indication via a MAC-CE.

In a fourth aspect, alone or in combination with one or more of the first through third aspects, process 600 includes transmitting, to the first UE, one or more of satellite ephemeris information, a UE location, or a reference location.

In a fifth aspect, alone or in combination with one or more of the first through fourth aspects, process 600 includes determining a reference location, and transmitting, to the first UE, a reference location indication associated with the reference location.

In a sixth aspect, alone or in combination with one or more of the first through fifth aspects, at least one of the one or more parameters is associated with a reference location.

In a seventh aspect, alone or in combination with one or more of the first through sixth aspects, the one or more parameters include one or more of an uplink Doppler frequency or a downlink Doppler frequency.

In an eighth aspect, alone or in combination with one or more of the first through seventh aspects, transmitting the cell type indication includes transmitting the cell type indication via one or more of a MIB, a SIB, or an RRC communication.

In a ninth aspect, alone or in combination with one or more of the first through eighth aspects, the cell type indication is associated with one or more information fields or one or more communication parameters.

In a tenth aspect, alone or in combination with one or more of the first through ninth aspects, the cell type indication is associated with a SIB19 communication.

In an eleventh aspect, alone or in combination with one or more of the first through tenth aspects, process 600 includes transmitting a second communication to a second UE operating in the TN mode.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication, in accordance with the present disclosure. The apparatus 700 may be a UE, or a UE may include the apparatus 700. In some aspects, the apparatus 700 includes a reception component 702, a transmission component 704, and/or a communication manager 706, which may be in communication with one another (for example, via one or more buses and/or one or more other components). In some aspects, the communication manager 706 is the communication manager 150 described in connection with FIG. 1. As shown, the apparatus 700 may communicate with another apparatus 708, such as a UE or a network node (such as a CU, a DU, an RU, or a base station), using the reception component 702 and the transmission component 704. The communication manager 706 may be included in, or implemented via, a processing system (for example, the processing system 140 described in connection with FIG. 1) of the UE.

In some aspects, the apparatus 700 may be configured to perform one or more operations described herein in connection with FIGS. 3-4. Additionally, or alternatively, the apparatus 700 may be configured to perform one or more processes described herein, such as process 500 of FIG. 5. In some aspects, the apparatus 700 and/or one or more components shown in FIG. 7 may include one or more components of the UE described in connection with FIG. 1. Additionally, or alternatively, one or more components shown in FIG. 7 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 702 may receive communications, such as reference signals, control information, data communications, or a combination thereof, from the apparatus 708. The reception component 702 may provide received communications to one or more other components of the apparatus 700. In some aspects, the reception component 702 may perform signal processing on the received communications, and may provide the processed signals to the one or more other components of the apparatus 700. In some aspects, the reception component 702 may include one or more components of the UE described above in connection with FIG. 1, such as a radio, one or more RF chains, one or more transceivers, or one or more modems, each of which may in turn be coupled with one or more antennas of the UE.

The transmission component 704 may transmit communications, such as reference signals, control information, data communications, or a combination thereof, to the apparatus 708. In some aspects, one or more other components of the apparatus 700 may generate communications and may provide the generated communications to the transmission component 704 for transmission to the apparatus 708. In some aspects, the transmission component 704 may perform signal processing on the generated communications, and may transmit the processed signals to the apparatus 708. In some aspects, the transmission component 704 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 704 may be co-located with the reception component 702.

The communication manager 706 may support operations of the reception component 702 and/or the transmission component 704. For example, the communication manager 706 may receive information associated with configuring reception of communications by the reception component 702 and/or transmission of communications by the transmission component 704. Additionally, or alternatively, the communication manager 706 may generate and/or provide control information to the reception component 702 and/or the transmission component 704 to control reception and/or transmission of communications.

The reception component 702 may receive a cell type indication for cell type information associated with a network node that supports communication via one or more of a TN mode or an NTN mode. The transmission component 704 may transmit, to the network node, a communication in accordance with one or more parameters for the NTN mode, wherein the one or more parameters for the NTN mode are associated with the cell type information of the network node that supports communication via the TN mode.

The transmission component 704 may transmit, to the network node, an NTN indication that indicates a capability associated with operating in the NTN mode. The reception component 702 may receive one or more of an NTN mode configuration or a TN mode configuration. The reception component 702 may receive, from the network node, a reference location indication associated with a reference location. The communication manager 706 may determine a residual downlink Doppler frequency compensating for the residual downlink Doppler frequency to reduce a downlink Doppler frequency error. The communication manager 706 may determine a residual uplink Doppler frequency compensating for the residual uplink Doppler frequency to reduce an uplink Doppler frequency error. The communication manager 706 may determine an uplink timing shift wherein transmitting the communication in accordance with the one or more parameters associated with the NTN mode includes transmitting the communication in accordance with the uplink timing shift.

The number and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

FIG. 8 is a diagram of an example apparatus 800 for wireless communication, in accordance with the present disclosure. The apparatus 800 may be a network node, or a network node may include the apparatus 800. In some aspects, the apparatus 800 includes a reception component 802, a transmission component 804, and/or a communication manager 806, which may be in communication with one another (for example, via one or more buses and/or one or more other components). In some aspects, the communication manager 806 is the communication manager 155 described in connection with FIG. 1. As shown, the apparatus 800 may communicate with another apparatus 808, such as a UE or a network node (such as a CU, a DU, an RU, or a base station), using the reception component 802 and the transmission component 804. The communication manager 806 may be included in, or implemented via, a processing system (for example, the processing system 145 described in connection with FIG. 1) of the network node.

In some aspects, the apparatus 800 may be configured to perform one or more operations described herein in connection with FIGS. 3-4. Additionally, or alternatively, the apparatus 800 may be configured to perform one or more processes described herein, such as process 600 of FIG. 6. In some aspects, the apparatus 800 and/or one or more components shown in FIG. 8 may include one or more components of the network node described in connection with FIG. 1. Additionally, or alternatively, one or more components shown in FIG. 8 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 802 may receive communications, such as reference signals, control information, data communications, or a combination thereof, from the apparatus 808. The reception component 802 may provide received communications to one or more other components of the apparatus 800. In some aspects, the reception component 802 may perform signal processing on the received communications, and may provide the processed signals to the one or more other components of the apparatus 800. In some aspects, the reception component 802 may include one or more components of the network node described above in connection with FIG. 1, such as a radio, one or more RF chains, one or more transceivers, or one or more modems, each of which may in turn be coupled with one or more antennas of the network node. In some aspects, the reception component 802 and/or the transmission component 804 may include or may be included in a network interface. The network interface may be configured to obtain and/or output signals for the apparatus 800 via one or more communications links, such as a backhaul link, a midhaul link, and/or a fronthaul link.

The transmission component 804 may transmit communications, such as reference signals, control information, data communications, or a combination thereof, to the apparatus 808. In some aspects, one or more other components of the apparatus 800 may generate communications and may provide the generated communications to the transmission component 804 for transmission to the apparatus 808. In some aspects, the transmission component 804 may perform signal processing on the generated communications, and may transmit the processed signals to the apparatus 808. In some aspects, the transmission component 804 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 804 may be co-located with the reception component 802.

The communication manager 806 may support operations of the reception component 802 and/or the transmission component 804. For example, the communication manager 806 may receive information associated with configuring reception of communications by the reception component 802 and/or transmission of communications by the transmission component 804. Additionally, or alternatively, the communication manager 806 may generate and/or provide control information to the reception component 802 and/or the transmission component 804 to control reception and/or transmission of communications.

The transmission component 804 may transmit, to a first UE, a cell type indication for cell type information associated with support for communication via one or more of a TN mode or an NTN mode. The reception component 802 may receive, from the first UE, a first communication in accordance with one or more parameters for the NTN mode, wherein the one or more parameters for the NTN mode are associated with the cell type information.

The reception component 802 may receive, from the first UE, an NTN indication that indicates a capability for the first UE to operate in the NTN mode. The transmission component 804 may transmit, to the first UE, one or more of satellite ephemeris information, a UE location, or a reference location. The communication manager 806 may determine a reference location. The transmission component 804 may transmit, to the first UE, a reference location indication associated with the reference location. The transmission component 804 may transmit a second communication to a second UE operating in the TN mode.

The number and arrangement of components shown in FIG. 8 are provided as an example. In practice, there may be additional components, fewer components, different components, or differently arranged components than those shown in FIG. 8. Furthermore, two or more components shown in FIG. 8 may be implemented within a single component, or a single component shown in FIG. 8 may be implemented as multiple, distributed components. Additionally, or alternatively, a set of (one or more) components shown in FIG. 8 may perform one or more functions described as being performed by another set of components shown in FIG. 8.

The following provides an overview of some Aspects of the present disclosure:
Aspect 1: A method of wireless communication performed by a UE, comprising: receiving a cell type indication for cell type information associated with a network node that supports communication via one or more of a TN mode or an NTN mode; and transmitting, to the network node, a communication in accordance with one or more parameters for the NTN mode, wherein the one or more parameters for the NTN mode are associated with the cell type information of the network node that supports communication via the TN mode.
Aspect 2: The method of Aspect 1, further comprising transmitting, to the network node, an NTN indication that indicates a capability associated with operating in the NTN mode.
Aspect 3: The method of Aspect 2, wherein transmitting the NTN indication includes transmitting the NTN indication via a PRACH preamble.
Aspect 4: The method of Aspect 2, wherein transmitting the NTN indication includes transmitting the NTN indication via a MAC-CE.
Aspect 5: The method of any of Aspects 1-4, further comprising receiving one or more of an NTN mode configuration or a TN mode configuration.
Aspect 6: The method of any of Aspects 1-5, wherein transmitting the communication includes applying the one or more parameters to the communication in accordance with at least one of satellite ephemeris information, a UE location, or a reference location.
Aspect 7: The method of any of Aspects 1-6, further comprising receiving, from the network node, a reference location indication associated with a reference location.
Aspect 8: The method of any of Aspects 1-7, wherein at least one of the one or more parameters is associated with a reference location.
Aspect 9: The method of any of Aspects 1-8, wherein the one or more parameters include one or more of an uplink Doppler frequency or a downlink Doppler frequency.
Aspect 10: The method of any of Aspects 1-9, further comprising: determining a residual downlink Doppler frequency; and compensating for the residual downlink Doppler frequency to reduce a downlink Doppler frequency error.
Aspect 11: The method of any of Aspects 1-10, further comprising: determining a residual uplink Doppler frequency; and compensating for the residual uplink Doppler frequency to reduce an uplink Doppler frequency error.
Aspect 12: The method of any of Aspects 1-11, further comprising determining an uplink timing shift, and wherein transmitting the communication in accordance with the one or more parameters associated with the NTN mode includes transmitting the communication in accordance with the uplink timing shift.
Aspect 13: The method of Aspect 12, wherein the uplink timing shift is associated with an offset value in accordance with at least one of a reference location, a UE location, or satellite ephemeris information.
Aspect 14: The method of any of Aspects 1-13, wherein receiving the cell type indication includes receiving the cell type indication via one or more of a MIB, a SIB, or an RRC communication.
Aspect 15: The method of any of Aspects 1-14, wherein receiving the cell type indication includes receiving the cell type indication while operating in the TN mode.
Aspect 16: The method of any of Aspects 1-15, wherein the cell type indication is associated with one or more information fields or one or more communication parameters.
Aspect 17: The method of any of Aspects 1-16, wherein the cell type indication is associated with a SIB19 communication.
Aspect 18: A method of wireless communication performed by a network node, comprising: transmitting, to a first UE, a cell type indication for cell type information associated with support for communication via one or more of a TN mode or an NTN mode; and receiving, from the first UE, a first communication in accordance with one or more parameters for the NTN mode, wherein the one or more parameters for the NTN mode are associated with the cell type information.
Aspect 19: The method of Aspect 18, further comprising receiving, from the first UE, an NTN indication that indicates a capability for the first UE to operate in the NTN mode.
Aspect 20: The method of Aspect 19, wherein receiving the NTN indication includes receiving the NTN indication via a PRACH preamble.
Aspect 21: The method of Aspect 19, wherein receiving the NTN indication includes receiving the NTN indication via a MAC-CE.
Aspect 22: The method of any of Aspects 18-21, further comprising transmitting, to the first UE, one or more of satellite ephemeris information, a UE location, or a reference location.
Aspect 23: The method of any of Aspects 18-22, further comprising: determining a reference location; and transmitting, to the first UE, a reference location indication associated with the reference location.
Aspect 24: The method of any of Aspects 18-23, wherein at least one of the one or more parameters is associated with a reference location.
Aspect 25: The method of any of Aspects 18-24, wherein the one or more parameters include one or more of an uplink Doppler frequency or a downlink Doppler frequency.
Aspect 26: The method of any of Aspects 18-25, wherein transmitting the cell type indication includes transmitting the cell type indication via one or more of a MIB, a SIB, or an RRC communication.
Aspect 27: The method of any of Aspects 18-26, wherein the cell type indication is associated with one or more information fields or one or more communication parameters.
Aspect 28: The method of any of Aspects 18-27, wherein the cell type indication is associated with a SIB19 communication.
Aspect 29: The method of any of Aspects 18-28, further comprising transmitting a second communication to a second UE operating in the TN mode.
Aspect 30: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-29.
Aspect 31: An apparatus for wireless communication at a device, the apparatus comprising one or more memories and one or more processors coupled to the one or more memories, the one or more processors configured to cause the device to perform the method of one or more of Aspects 1-29.
Aspect 32: An apparatus for wireless communication, the apparatus comprising at least one means for performing the method of one or more of Aspects 1-29.
Aspect 33: A non-transitory computer-readable medium storing code for wireless communication, the code comprising instructions executable by one or more processors to perform the method of one or more of Aspects 1-29.
Aspect 34: A non-transitory computer-readable medium storing a set of instructions for wireless communication, the set of instructions comprising one or more instructions that, when executed by one or more processors of a device, cause the device to perform the method of one or more of Aspects 1-29.
Aspect 35: A device for wireless communication, the device comprising a processing system that includes one or more processors and one or more memories coupled with the one or more processors, the processing system configured to cause the device to perform the method of one or more of Aspects 1-29.
Aspect 36: An apparatus for wireless communication at a device, the apparatus comprising one or more memories and one or more processors coupled to the one or more memories, the one or more processors individually or collectively configured to cause the device to perform the method of one or more of Aspects 1-29.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a cell type indication for cell type information associated with a network node that supports communication via one or more of a terrestrial network mode or a non-terrestrial network (NTN) mode; and
transmit, to the network node, a communication in accordance with one or more parameters for the NTN mode, wherein the one or more parameters for the NTN mode are associated with the cell type information of the network node that supports communication via the terrestrial network mode.

2. The UE of claim 1, wherein the one or more processors are further configured to cause the UE to transmit, to the network node, an NTN indication that indicates a capability associated with operating in the NTN mode.

3. The UE of claim 2, wherein the one or more processors, to cause the UE to transmit the NTN indication, are configured to cause the UE to transmit the NTN indication via a physical random access channel preamble.

4. The UE of claim 2, wherein the one or more processors, to cause the UE to transmit the NTN indication, are configured to cause the UE to transmit the NTN indication via a medium access control (MAC) control element.

5. The UE of claim 1, wherein the one or more processors are further configured to cause the UE to receive an NTN mode configuration.

6. The UE of claim 1, wherein the one or more processors, to cause the UE to transmit the communication, are configured to cause the UE to apply the one or more parameters to the communication in accordance with at least one of satellite ephemeris information, a UE location, or a reference location.

7. The UE of claim 1, wherein the one or more processors are further configured to cause the UE to receive, from the network node, a reference location indication associated with a reference location.

8. The UE of claim 1, wherein at least one of the one or more parameters is associated with a reference location.

9. The UE of claim 1, wherein the one or more parameters include one or more of an uplink Doppler frequency or a downlink Doppler frequency.

10. The UE of claim 1, wherein the one or more processors are further configured to cause the UE to:
determine a residual downlink Doppler frequency; and
compensate for the residual downlink Doppler frequency to reduce a downlink Doppler frequency error.

11. The UE of claim 1, wherein the one or more processors are further configured to cause the UE to:
determine a residual uplink Doppler frequency; and
compensate for the residual uplink Doppler frequency to reduce an uplink Doppler frequency error.

12. The UE of claim 1, wherein the one or more processors are further configured to cause the UE to determine an uplink timing shift, and wherein the one or more processors, to cause the UE to transmit the communication in accordance with the one or more parameters associated with the NTN mode, are configured to cause the UE to transmit the communication in accordance with the uplink timing shift.

13. The UE of claim 12, wherein the uplink timing shift is associated with an offset value in accordance with at least one of a reference location, a UE location, or satellite ephemeris information.

14. The UE of claim 1, wherein the one or more processors, to cause the UE to receive the cell type indication, are configured to cause the UE to receive the cell type indication via one or more of a master information block, a system information block, or a radio resource control (RRC) communication.

15. The UE of claim 1, wherein the one or more processors, to cause the UE to receive the cell type indication, are configured to cause the UE to receive the cell type indication while operating in the terrestrial network mode.

16. The UE of claim 1, wherein the cell type indication is associated with one or more information fields or one or more communication parameters.

17. The UE of claim 1, wherein the cell type indication is associated with a system information block 19 (SIB19) communication.

18. A network node for wireless communication, comprising:
one or more memories; and
one or more processors, coupled to the one or more memories, configured to cause the network node to:
transmit, to a first user equipment (UE), a cell type indication for cell type information associated with support for communication via one or more of a terrestrial network mode or a non-terrestrial network (NTN) mode; and
receive, from the first UE, a first communication in accordance with one or more parameters for the NTN mode, wherein the one or more parameters for the NTN mode are associated with the cell type information.

19. The network node of claim 18, wherein the one or more processors are further configured to cause the network node to receive, from the first UE, an NTN indication that indicates a capability for the first UE to operate in the NTN mode.

20. The network node of claim 18, wherein the one or more processors are further configured to cause the network node to transmit, to the first UE, one or more of satellite ephemeris information, a UE location, or a reference location.

21. The network node of claim 18, wherein the one or more processors are further configured to cause the network node to:
determine a reference location; and
transmit, to the first UE, a reference location indication associated with the reference location.

22. The network node of claim 18, wherein at least one of the one or more parameters is associated with a reference location.

23. The network node of claim 18, wherein the one or more parameters include one or more of an uplink Doppler frequency or a downlink Doppler frequency.

24. The network node of claim 18, wherein the one or more processors, to cause the network node to transmit the cell type indication, are configured to cause the network node to transmit the cell type indication via one or more of a master information block, a system information block, or a radio resource control (RRC) communication.

25. The network node of claim 18, wherein the cell type indication is associated with one or more information fields or one or more communication parameters.

26. The network node of claim 18, wherein the cell type indication is associated with a system information block 19 (SIB19) communication.

27. The network node of claim 18, wherein the one or more processors are further configured to cause the network node to transmit a second communication to a second UE operating in the terrestrial network mode.

28. The network node of claim 18, wherein the one or more processors are further configured to cause the network node to schedule resources for the first communication in accordance with the NTN mode.

29. A method of wireless communication performed by a user equipment (UE), comprising:
receiving a cell type indication for cell type information associated with a network node that supports communication via one or more of a terrestrial network mode or a non-terrestrial network (NTN) mode; and
transmitting, to the network node, a communication in accordance with one or more parameters for the NTN mode, wherein the one or more parameters for the NTN mode are associated with the cell type information of the network node that supports communication via the terrestrial network mode.

30. A method of wireless communication performed by a network node, comprising:
transmitting, to a first user equipment (UE), a cell type indication for cell type information associated with support for communication via one or more of a terrestrial network mode or a non-terrestrial network (NTN) mode; and
receiving, from the first UE, a first communication in accordance with one or more parameters for the NTN mode, wherein the one or more parameters for the NTN mode are associated with the cell type information.
